(19) United States
(12) Patent Application Publication
(10) Pub. No.: US 2015/0215880 A1
(43) Pub. Date: Jul. 30, 2015

(54) DEVICES AND METHODS FOR LOCATING RECEIVED TONES IN WIRELESS COMMUNICATIONS SYSTEMS

(71) Applicant: QUALCOMM Incorporated, San Diego, CA (US)

(72) Inventors: Hassan Rafique, Farnborough (GB); Divaydeep Sikri, Farnborough (GB); Cetin Altan, Farnborough (GB)

(73) Assignee: QUALCOMM Incorporated, San Diego, CA (US)

(21) Appl. No.: 14/166,614

(22) Filed: Jan. 28, 2014

(51) Int. Cl. H04W 56/00; H04B 7/26; H04W 24/08

(52) U.S. Cl. CPC H04W 56/001; H04W 24/08; H04B 7/2681

(57) ABSTRACT

Access terminals are adapted to determine a tone location even when the tone is asymmetric. According to one example, an access terminal can obtain a plurality of samples for a received tone. The access terminal may detect which sample of the plurality of samples exhibits a maximum correlation value. The access terminal may further determine a location of the received tone based on the sample exhibiting the maximum correlation value. In some examples, the location of the received tone may be determine based on the sample exhibiting the maximum correlation value when a predicted signal-to-noise ratio (SNR) is above a predetermined threshold. Otherwise, the access terminal may determine the tone location based on a central location between a first sample with a correlation value above a predefined threshold and a first subsequent sample with a correlation value below the predefined threshold. Other aspects, embodiments, and features are also included.

### TECHNICAL FIELD

The technology discussed below relates generally to wireless communications, and more specifically to methods and devices for facilitating tone location by access terminals operating in a wireless communications system for more accurate timing synchronization of such access terminals with a cell.

### BACKGROUND

Wireless communications systems are widely deployed to provide various types of communication content such as voice, video, packet data, messaging, broadcast, and so on. These systems may be accessed by various types of devices adapted to facilitate wireless communications, where multiple devices share the available system resources (e.g., time, frequency, and power). Examples of such wireless communications systems include code-division multiple access (CDMA) systems, time-division multiple access (TDMA) systems, frequency-division multiple access (FDMA) systems and orthogonal frequency-division multiple access (OFDMA) systems.

Multiple types of devices are adapted to utilize such wireless communications systems. These devices may be generally referred to as access terminals. Wireless communications systems and access terminals that operate therein continue to become more and more ubiquitous. As the demand for wireless communications continues to increase, the development and advancement of access terminals adapted to operate within wireless communications systems continues to advance and enhance the user experience with wireless communications.

### BRIEF SUMMARY OF SOME EXAMPLES

The following summarizes some aspects of the present disclosure to provide a basic understanding of the discussed technology. This summary is not an extensive overview of all contemplated features of the disclosure, and is intended neither to identify key or critical elements of all aspects of the disclosure nor to delineate the scope of any or all aspects of the disclosure. Its sole purpose is to present some concepts of one or more aspects of the disclosure in summary form as a prelude to the more detailed description that is presented later.

Various examples and implementations of the present disclosure facilitate determining a received tone location in a wireless communications system. According to at least one example, an access terminal may include a communications interface coupled with a processing circuit. The processing circuit may be adapted to receive a transmitted tone via the communications interface and obtain a plurality of samples for the received tone. The processing circuit may further be adapted to determine a location of the received tone based on a sample exhibiting a maximum correlation value.

In some examples, the processing circuit may be adapted to determine the location of the received tone based on the sample exhibiting the maximum correlation value when a predicted signal-to-noise ratio (SNR) is equal to or above a predetermined SNR threshold. When the predicted SNR is below the predetermined SNR threshold, the processing circuit may be adapted to determine the location of the received tone based on a location halfway between a first sample with a correlation value above a predefined correlation threshold and a first subsequent sample with a correlation value below the predefined correlation threshold.

Further aspects provide methods operational on access terminals and/or access terminals including means to perform such methods. One or more examples of such methods may include obtaining a plurality of samples for a received tone. A sample exhibiting a maximum correlation value may be detected from among the plurality of samples. A location for the received tone may be determined based on the sample exhibiting the maximum correlation value. In some examples, the location for the received tone may be determined based on the sample exhibiting the maximum correlation value when a predicted signal-to-noise ratio is above a predetermined SNR threshold. If the predicted signal-to-noise ratio for the received tone is below the predetermined SNR threshold, the location of the received tone may be determined based on a central location between a first sample with a correlation value above a predefined correlation threshold and a first subsequent sample with a correlation value below the predefined correlation threshold.

Still further aspects include processor-readable storage mediums comprising programming executable by a processing circuit. According to one or more examples, such programming may be adapted for causing the processing circuit to obtain a plurality of samples for a received tone, detect which sample of the plurality of samples exhibits a maximum correlation value, and determine a location of the received tone based on the sample exhibiting the maximum correlation value. In some examples, the programming may be adapted to determine the location of the received tone based on the sample exhibiting the maximum correlation value when the predicted signal-to-noise ratio (SNR) is above a predetermined SNR threshold, and determine a location of the received tone based on a central location between a first sample with a correlation value above a predefined correlation threshold and a first subsequent sample with a correlation value below the predefined correlation threshold when the predicted signal-to-noise ratio for the received tone is below the predetermined SNR threshold.

Other aspects, features, and embodiments associated with the present disclosure will become apparent to those of ordinary skill in the art upon reviewing the following description in conjunction with the accompanying figures.

### BRIEF DESCRIPTION OF THE DRAWINGS

FIG. 1 is a block diagram of a network environment in which one or more aspects of the present disclosure may find application.

FIG. 2 is a block diagram illustrating components of the wireless communication system of FIG. 1 according to some embodiments.

FIG. 3 is a diagram illustrating samples obtained for pilot tone according to some embodiments.

FIG. 4 is a block diagram illustrating select components of an access terminal according to some embodiments.

FIG. 5 is a flow diagram illustrating a method operational on an access terminal according to some embodiments.

FIG. 6 is a flow diagram illustrating a method operational on an access terminal according to some embodiments.

### DETAILED DESCRIPTION

The description set forth below in connection with the appended drawings is intended as a description of various configurations and is not intended to represent the only configurations in which the concepts and features described herein may be practiced. The following description includes specific details for the purpose of providing a thorough understanding of various concepts. However, it will be apparent to those skilled in the art that these concepts may be practiced without these specific details. In some instances, well known circuits, structures, techniques and components are shown in block diagram form to avoid obscuring the described concepts and features.

The various concepts presented throughout this disclosure may be implemented across a broad variety of telecommunication systems, network architectures, and communication standards. Certain aspects of the disclosure are described below for 3rd Generation Partnership Project (3GPP) protocols and systems, and related terminology may be found in much of the following description. However, those of ordinary skill in the art will recognize that one or more aspects of the present disclosure may be employed and included in one or more other wireless communication protocols and systems.

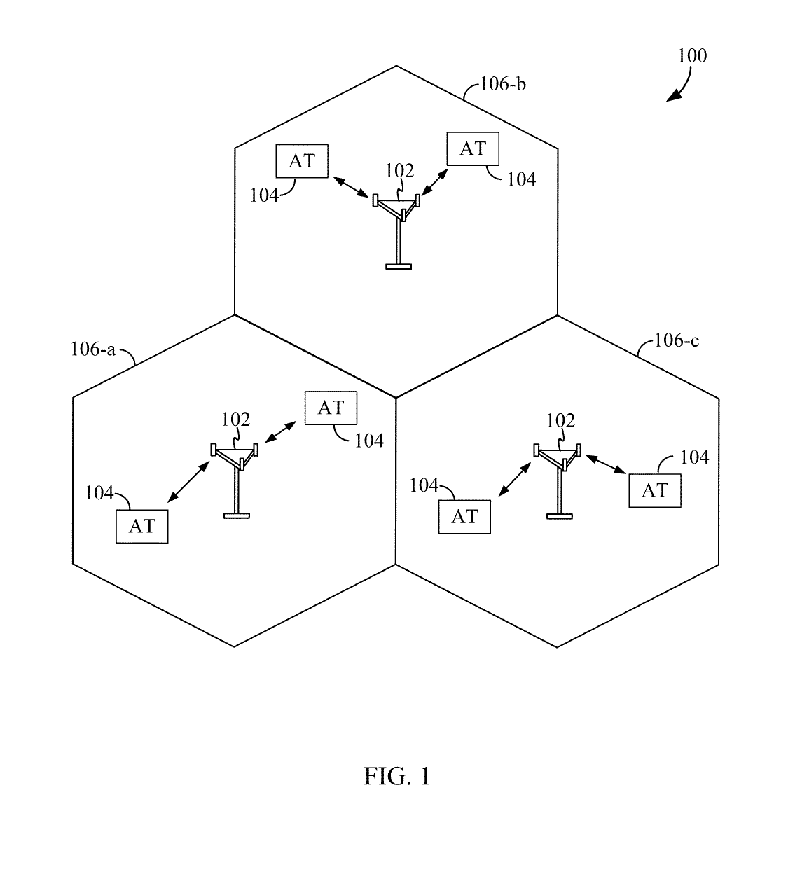

Referring now to FIG. 1, a block diagram of a network environment in which one or more aspects of the present disclosure may find application is illustrated. The wireless communications system 100 is adapted to facilitate wireless communication between one or more base stations 102 and access terminals 104. The base stations 102 and access terminals 104 may be adapted to interact with one another through wireless signals. In some instances, such wireless interaction may occur on multiple carriers (waveform signals of different frequencies). Each modulated signal may carry control information (e.g., pilot signals), overhead information, data, etc.

The base stations 102 can wirelessly communicate with the access terminals 104 via a base station antenna. The base stations 102 may each be implemented generally as a device adapted to facilitate wireless connectivity (for one or more access terminals 104) to the wireless communications system 100. Such a base station 102 may also be referred to by those skilled in the art as a base transceiver station (BTS), a radio base station, a radio transceiver, a transceiver function, a basic service set (BSS), and extended service set (ESS), a node B, a femto cell, a pico cell, or some other suitable terminology.

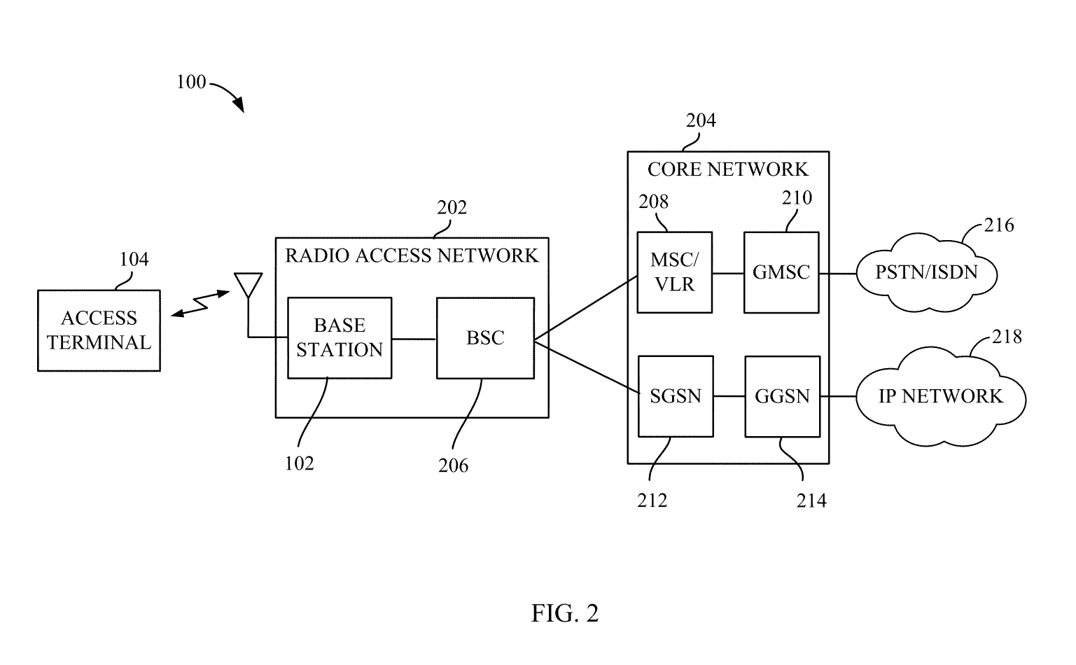

The base stations 102 are configured to communicate with the access terminals 104 under the control of a base station controller (see FIG. 2). Each of the base station 102 sites can provide communication coverage for a respective geographic area. The coverage area 106 for each base station 102 here is identified as cells 106-a, 106-b, or 106-c. The coverage area 106 for a base station 102 may be divided into sectors (not shown, but making up only a portion of the coverage area). In various examples, the system 100 may include base stations 102 of different types.

One or more access terminals 104 may be dispersed throughout the coverage areas 106. Each access terminal 104 may communicate with one or more base stations 102. An access terminal 104 may generally include one or more devices that communicate with one or more other devices through wireless signals. Such an access terminal 104 may also be referred to by those skilled in the art as a user equipment (UE), a mobile station (MS), a subscriber station, a mobile unit, a subscriber unit, a wireless unit, a remote unit, a mobile device, a wireless device, a wireless communications device, a remote device, a mobile subscriber station, a mobile terminal, a wireless terminal, a remote terminal, a handset, a terminal, a user agent, a mobile client, a client, or some other suitable terminology. An access terminal 104 may include a mobile terminal and/or an at least substantially fixed terminal. Examples of an access terminal 104 include a mobile phone, a pager, a wireless modem, a personal digital assistant, a personal information manager (PIM), a personal media player, a palmtop computer, a laptop computer, a tablet computer, a television, an appliance, an e-reader, a digital video recorder (DVR), a machine-to-machine (M2M) device, meter, entertainment device, sensor, sensing device, wearable device, router, and/or other communication/computing device which communicates, at least partially, through a wireless or cellular network.

Turning to FIG. 2, a block diagram illustrating select components of the wireless communication system 100 is depicted according to at least one example. As illustrated, the base stations 102 are included as at least a part of a radio access network (RAN) 202. The radio access network (RAN) 202 is generally adapted to manage traffic and signaling between one or more access terminals 104 and one or more other network entities, such as network entities included in a core network 204. The radio access network 202 may, according to various implementations, be referred to by those skill in the art as a base station subsystem (BSS), an access network, a GSM Edge Radio Access Network (GERAN), a UMTS Terrestrial Radio Access Network (UTRAN), etc.

In addition to one or more base stations 102, the radio access network 202 can include a base station controller (BSC) 206, which may also be referred to by those of skill in the art as a radio network controller (RNC). The base station controller 206 is generally responsible for the establishment, release, and maintenance of wireless connections within one or more coverage areas associated with the one or more base stations 102 which are connected to the base station controller 206. The base station controller 206 can be communicatively coupled to one or more nodes or entities of the core network 204.

The core network 204 is a portion of the wireless communications system 100 that provides various services to access terminals 104 that are connected via the radio access network 202. The core network 204 may include a circuit-switched (CS) domain and a packet-switched (PS) domain. Some examples of circuit-switched entities include a mobile switching center (MSC) and visitor location register (VLR), identified as MSC/VLR 208, as well as a Gateway MSC (GMSC) 210. Some examples of packet-switched elements include a Serving GPRS Support Node (SGSN) 212 and a Gateway GPRS Support Node (GGSN) 214. Other network entities may be included, such as an EIR, a HLR, a VLR and/or a AuC, some or all of which may be shared by both the circuit-switched and packet-switched domains. An access terminal 104 can obtain access to a public switched telephone network (PSTN) 216 via the circuit-switched domain, and to an IP network 218 via the packet-switched domain.

As access terminals 104 operate within the wireless communications system 100, an access terminal 104 may monitor one or more control channel carriers associated with a particular cell. An access terminal typically acquires control channel by an acquisition procedure. In general, a cell can transmit a pilot signal that is typically a radio burst transmitted during a first burst period on a Frequency Correction Channel (FCCH). The pilot signal includes a pre-defined sequence (e.g., an all-zero sequence) that produces a fixed tone (e.g., at 67.7 KHz in the Gaussian minimum-shift keying (GMSK) modulator output). This tone enables the access terminal 104 to lock its local oscillator to the clock of the base station 102 for frequency synchronization. The Frequency Correction Channel (FCCH) is typically transmitted in a frame immediately before a Synchronization Channel (SCH), which Synchronization Channel (SCH) enables the access terminal 104 to quickly identify the cell and synchronize to the cell's timing structures (e.g., TDMA structures).

Typically, an access terminal 104 is configured to locate the end of the tone. One conventional mechanism for locating the tone is based on an autocorrelation response. The autocorrelation response is computed based on a sliding window, the duration of which matches the tone duration being transmitted by the base station 102. When the window encounters the tone, the correlation starts rising. When the window starts exiting the tone, the correlation would start to fall, in a symmetric manner.

Conventional tone location includes monitoring the correlation value for each sample, and noting the first sample (S1) where the correlation value is above a predefined threshold. If the correlation values for each subsequent sample stays above the threshold for a minimum number of samples, then the sample (S2) that falls below the threshold again is noted. The end of the tone (E) can then be defined by the equation

E=(S1+S2)/2.

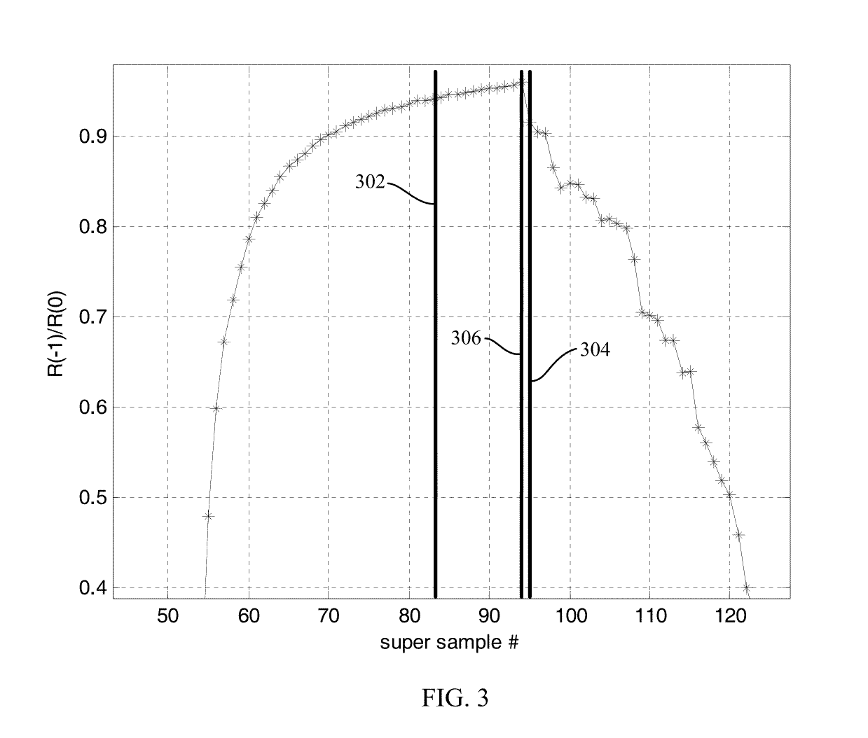

The accuracy of this algorithm, however, is typically dependent on the autocorrelation response being symmetric. In some instances, a tone capture may become asymmetric under partial tone captures, which can occur in fading scenarios where the tone is blocked or cancelled after being partially captured. For example, FIG. 3 is a diagram illustrating samples obtained for pilot tone. As illustrated, the detected tone samples rise smoothly at the beginning (or left-hand side), but fall off at the right-hand side, resulting in an asymmetric received tone. In this example, the access terminal 104 utilizing the conventional method will typically identify the end of the tone at a position indicated at line 302. The actual end of the tone, however, is indicated at line 304. Thus, the presence of asymmetry may be inaccurate, in some scenarios.

According to an aspect of the present disclosure, access terminals are adapted to more accurately detect a tone, even when the tone capture results in an asymmetric tone. In some instances, the access terminal may use a peak correlation detection described in more detail below to accurately find the tone. Some access terminals may select between the conventional autocorrelation detection and the peak correlation detection based on a predicted signal-to-noise ratio (SNR) associated with the received tone.

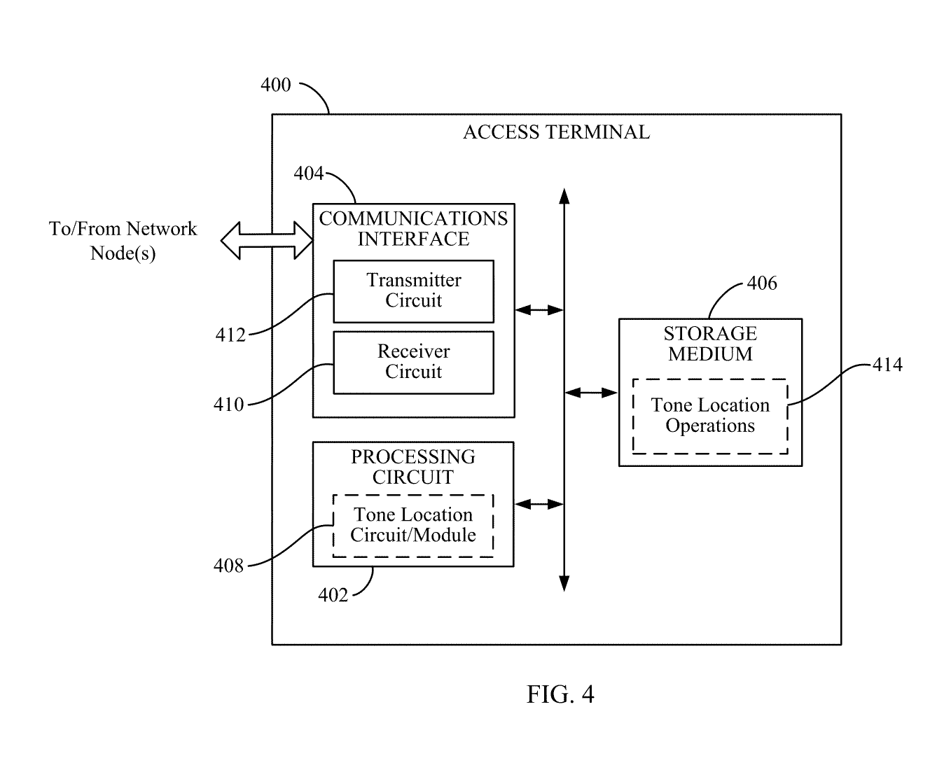

Turning to FIG. 4, a block diagram is shown illustrating select components of an access terminal 400 according to at least one example of the present disclosure. The access terminal 400 includes a processing circuit 402 coupled to or placed in electrical communication with a communications interface 404 (e.g., a transceiver, transmitter, and/or receiver) and a storage medium 406.

The processing circuit 402 is arranged to obtain, process and/or send data, control data access and storage, issue commands, and control other desired operations. The processing circuit 402 may include circuitry adapted to implement desired programming provided by appropriate media, and/or circuitry adapted to perform one or more functions described in this disclosure. For example, the processing circuit 402 may be implemented as one or more processors, one or more controllers, and/or other structure configured to execute executable programming Examples of the processing circuit 402 may include a general purpose processor, a digital signal processor (DSP), an application specific integrated circuit (ASIC), a field programmable gate array (FPGA) or other programmable logic component, discrete gate or transistor logic, discrete hardware components, or any combination thereof designed to perform the functions described herein. A general purpose processor may include a microprocessor, as well as any conventional processor, controller, microcontroller, or state machine. The processing circuit 402 may also be implemented as a combination of computing components, such as a combination of a DSP and a microprocessor, a number of microprocessors, one or more microprocessors in conjunction with a DSP core, an ASIC and a microprocessor, or any other number of varying configurations. These examples of the processing circuit 402 are for illustration and other suitable configurations within the scope of the present disclosure are also contemplated.

The processing circuit 402 may be adapted for processing, including the execution of programming, which may be stored on the storage medium 406. As used herein, the term “programming” shall be construed broadly to include without limitation instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise.

In some instances, the processing circuit 402 may include a tone location circuit and/or module 408. The tone location circuit and/or module 408 may include circuitry and/or programming (e.g., programming stored on the storage medium 406) adapted to detect a received tone, even when the received tone signal is asymmetric.

The communications interface 404 is configured to facilitate wireless communications of the access terminal 400. For example, the communications interface 404 may include circuitry and/or programming adapted to facilitate the communication of information bi-directionally with respect to one or more wireless network devices (e.g., network nodes). The communications interface 404 may be coupled to one or more antennas (not shown), and includes wireless transceiver circuitry, including at least one receiver circuit 410 (e.g., one or more receiver chains) and/or at least one transmitter circuit 412 (e.g., one or more transmitter chains).

The storage medium 406 may represent one or more processor-readable devices for storing programming, such as processor executable code or instructions (e.g., software, firmware), electronic data, databases, or other digital information. The storage medium 406 may also be used for storing data that is manipulated by the processing circuit 402 when executing programming. The storage medium 406 may be any available media that can be accessed by a general purpose or special purpose processor, including portable or fixed storage devices, optical storage devices, and various other mediums capable of storing, containing and/or carrying programming. By way of example and not limitation, the storage medium 406 may include a processor-readable storage medium such as a magnetic storage device (e.g., hard disk, floppy disk, magnetic strip), an optical storage medium (e.g., compact disk (CD), digital versatile disk (DVD)), a smart card, a flash memory device (e.g., card, stick, key drive), random access memory (RAM), read only memory (ROM), programmable ROM (PROM), erasable PROM (EPROM), electrically erasable PROM (EEPROM), a register, a removable disk, and/or other mediums for storing programming, as well as any combination thereof.

The storage medium 406 may be coupled to the processing circuit 402 such that the processing circuit 402 can read information from, and write information to, the storage medium 406. That is, the storage medium 406 can be coupled to the processing circuit 402 so that the storage medium 406 is at least accessible by the processing circuit 402, including examples where the storage medium 406 is integral to the processing circuit 402 and/or examples where the storage medium 406 is separate from the processing circuit 402 (e.g., resident in the access terminal 400, external to the access terminal 400, distributed across multiple entities).

Programming stored by the storage medium 406, when executed by the processing circuit 402, causes the processing circuit 402 to perform one or more of the various functions and/or process steps described herein. In at least some examples, the storage medium 406 may include tone location operations 414 adapted to cause the processing circuit 402 to locate a received tone signal, even if the received tone signal is asymmetric, as described herein. Thus, according to one or more aspects of the present disclosure, the processing circuit 402 is adapted to perform (in conjunction with the storage medium 406) any or all of the processes, functions, steps and/or routines for any or all of the access terminals described herein (e.g., access terminal 104, access terminal 400). As used herein, the term “adapted” in relation to the processing circuit 402 may refer to the processing circuit 402 being one or more of configured, employed, implemented, and/or programmed (in conjunction with the storage medium 406) to perform a particular process, function, step and/or routine according to various features described herein.

In operation, the access terminal 400 can detect a received tone. In some scenarios, the received tone signal may be asymmetric. In one example, the access terminal 400 may detect a received tone by identifying a peak correlation value associated with the received tone. That is, the access terminal 400 can select a sample with a maximum (or peak) correlation value instead of the conventional algorithm for determining the end of the autocorrelation response. Referring back to FIG. 3, the access terminal 400 may choose the maximum point 306 in the autocorrelation response. That is, the access terminal 400 selects the peak sample (e.g., at line 306) as the end of the tone, which results in a significantly better tone detection compared to the conventional method which detected point 302. In other words, the point at line 306 is significantly closer to the actual end at line 304 than the conventionally detected point at line 302.

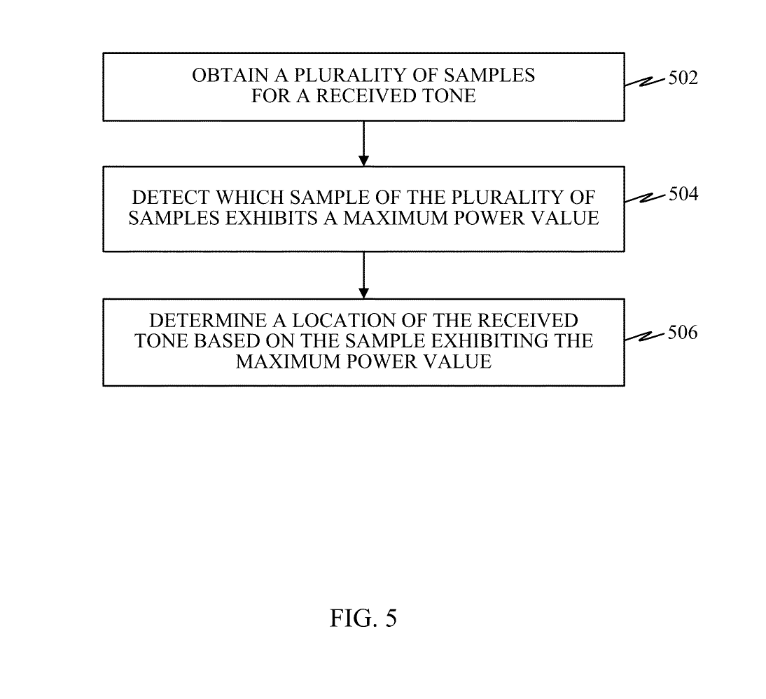

FIG. 5 is a flow diagram illustrating at least one example of a method operational on an access terminal, such as the access terminal 400. Referring to FIGS. 4 and 5, an access terminal 400 can initially obtain a plurality of samples for a received tone at 502. For example, the processing circuit 402 (e.g., the tone location circuit/module 408) executing the tone location operations 414 may receive a transmitted tone via the communications interface 404, and may obtain a plurality of samples for the received tone.

At 504, the access terminal 400 can detect which sample of the plurality of samples exhibits a maximum correlation value. For example, the processing circuit 402 (e.g., the tone location circuit/module 408) executing the tone location operations 414 can monitor the correlation value associated with each sample of the received tone during a receive window, and can maintain a running maximum of the correlation. That is, the processing circuit 402 (e.g., the tone location circuit/module 408) executing the tone location operations 414 can maintain an indicator for a sample with a highest correlation value, and can replace that indicator if a subsequent sample exhibits a higher correlation value. This monitoring may occur during a window having a duration at least substantially equal to the tone duration transmitted by the network entity (e.g., a time duration of about 142 symbols).

When the access terminal 400 identifies the sample exhibiting the peak correlation value, the access terminal 400 can determine a location of the received tone based on that identified sample, at 506. For example, the processing circuit 402 (e.g., the tone location circuit/module 408) executing the tone location operations 414 can determine that the end of the tone is located at the sample with the maximum correlation value.

By detecting the sample with the peak correlation value, the access terminal 400 can improve tone location in partial tone scenarios and can increase accuracy of tone location. After the tone is located, the access terminal 400 can complete synchronization with the timing structures of the cell. More accurate tone location can lead to more accurate synchronization with the cell's timing structures. More accurate synchronization can be useful when timelines are relatively tight and error margins are relatively low.

In some examples, when the noise power gets relatively high, the sample correlation values may bounce around such that the peak sample detection just described may not be sufficiently reliable. According to an aspect of the present disclosure, the access terminal 400 may be adapted to employ different autocorrelation algorithms depending on the signal-to-noise ratio (SNR).

Typically, however, the signal-to-noise ratio (SNR) is not known until after the tone has been located. This is due to the signal-to-noise ratio (SNR) estimate for the tone not being calculated until after the tone has been located. Additionally, if current signal-to-noise ratio calculations were used to calculate the signal-to-noise ratio early, the results would be unreliable in partial tone scenarios.

According to an aspect of the present disclosure, the access terminal 400 may be adapted to predict the signal-to-noise ratio (SNR) from the peak correlation value. In at least one example, the access terminal 400 can employ the maximum correlation value (ρₘₐₓ) of the autocorrelation response to predict the SNR according to the equation

$$SNR = \frac{1}{1 \text{/} {ρ}_{max} - 1} .$$

This SNR prediction equation can be employed based on the assumption that the receive window includes only the tone transmission. For example, when s(k) is the transmitted signal and N(k) is the AWGN noise, total power is described by the equation x(k)=s(k)+N(k). The coherent sum can be described by the equation

$$r ( n ) = {\sum }_{i = 0}^{N - 1} x ( N * n + i )$$

$$or$$

$$R ( k , n ) = {\sum }_{i = n}^{n + L} r ( i ) * rH ( i + k ) ,$$

where ‘R’ is the correlation value and ‘H’ is the Hermitian (e.g., the conjugate transpose).

Solving for a particular correlation value can be described by the ratio

$$ρ [ n ] = \frac{R ( 1 , n )}{R ( 0 , n + 1 )} .$$

When only the tone is in the receive window, a simplistic version (N=1) of (4) for the maximum correlation value becomes

$${ρ}_{max} = \frac{α 2 {Σ}_{i = 0}^{L} s [ i ] * sH [ i + 1 ] + {Σ}_{i = 0}^{L} N [ i ] * NH [ i + 1 ]}{α 2 {Σ}_{i = 0}^{L} s [ i + 1 ] * sH [ i + 1 ] + {Σ}_{i = 0}^{L} N [ i + 1 ] * NH [ i + 1 ]}$$

At this point, s[i], and s[i+1] are the same since the signal is a frequency tone, and the equation can simplify to

$${ρ}_{max} = \frac{α 2 {Σ}_{i = 0}^{L} s 2 [ i ]}{α 2 {Σ}_{i = 0}^{L} s 2 [ i ] + {Σ}_{i = 0}^{L} N 2 [ i + 1 ]} ,$$

which further simplifies to

$${ρ}_{max} = \frac{α 2 L}{α 2 L + {Lσ}_{N}^{2}} .$$

The signal-to-noise ratio (SNR) is typically expressed as SNR=α²/σ_{N}², such that the previous expression for the maximum correlation value can be expressed as

$${ρ}_{mzx} = \frac{1}{1 + 1 \text{/} SNR} .$$

Solving for the SNR, the result is the equation above

$$SNR = \frac{1}{1 \text{/} {ρ}_{max} - 1} .$$

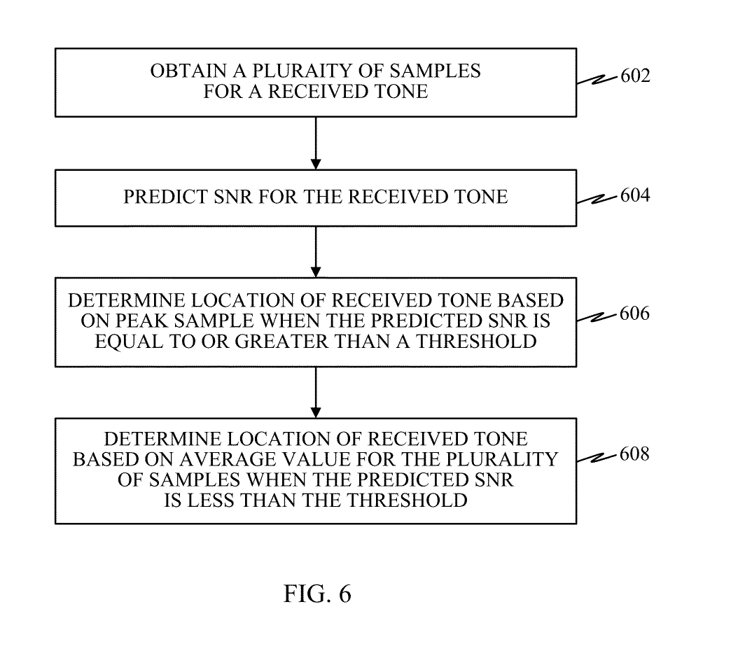

Thus, the access terminal 400 can predict the signal-to-noise ratio (SNR) for a received tone prior to locating the tone. The access terminal 400 can subsequently determine which tone location algorithm to use in determining the location of the tone based on the calculated signal-to-noise ratio (SNR) prediction. Turning now to FIG. 6, a flow diagram is shown illustrating at least one example of a method operational on an access terminal, such as the access terminal 400. With reference to FIGS. 4 and 6, an access terminal 400 can obtain a plurality of samples for a received tone at 602. For example, the processing circuit 402 (e.g., the tone location circuit/module 408) executing the tone location operations 414 may receive a transmitted tone via the communications interface 404, and may obtain a plurality of samples for the received tone.

At 604, the access terminal 400 can predict the signal-to-noise ratio (SNR) for the received tone prior to locating the tone. For example, the processing circuit 402 (e.g., the tone location circuit/module 408) executing the tone location operations 414 can calculate a signal-to-noise ratio (SNR) prediction. The processing circuit 402 (e.g., the tone location circuit/module 408) executing the tone location operations 414 can perform this calculation by first obtaining a plurality of samples for the received tone, and detecting the sample with the maximum correlation value. That is, the processing circuit 402 (e.g., the tone location circuit/module 408) executing the tone location operations 414 can monitor the correlation value associated with each sample of the received tone during a receive window, and can maintain a running maximum of the correlation. This monitoring may occur during a receive window having a duration at least substantially equal to the tone duration transmitted by the network entity.

When the sample exhibiting the peak correlation value (e.g., the peak sample) is detected, the processing circuit 402 (e.g., the tone location circuit/module 408) executing the tone location operations 414 can calculate the signal-to-noise ratio (SNR) for the sample with the maximum correlation value (e.g., the peak sample) using the equation

$$SNR = \frac{1}{1 \text{/} {ρ}_{max} - 1} .$$

If the calculated signal-to-noise ratio (SNR) prediction is greater than, or equal to a predetermined threshold, the access terminal 400 can determine the location of the received tone based on the sample exhibiting the peak correlation value (e.g., the peak sample) at 606. For example, the processing circuit 402 (e.g., the tone location circuit/module 408) executing the tone location operations 414 can determine that the end of the tone is located at least substantially at the same location as the sample with the maximum correlation value (e.g., the peak sample).

On the other hand, if the calculated signal-to-noise ratio (SNR) prediction is less than the predetermined threshold, the access terminal 400 can determine the location of the received tone based on the conventional calculation for the autocorrelation response values. That is, the processing circuit 402 (e.g., the tone location circuit/module 408) executing the tone location operations 414 can determine the location of the tone in time based on a central location between a first sample with a correlation value above a predetermined threshold and a first subsequent sample with a correlation value below the predetermined threshold. For example, the processing circuit 402 (e.g., the tone location circuit/module 408) executing the tone location operations 414 can monitor the correlation values for each sample, and can identify when a first sample (S1) exhibits a correlation value above a predefined threshold. If the correlation values for at least a predefined number of subsequent samples stays above the threshold, the processing circuit 402 (e.g., the tone location circuit/module 408) executing the tone location operations 414 can identify the first sample (S2) of the subsequent samples with a correlation value below the threshold. Employing the locations of the sample (S1) that first exceeded the threshold, and the subsequent sample (S2) that first fell below the threshold after sample S1, the processing circuit 402 (e.g., the tone location circuit/module 408) executing the tone location operations 414 can calculate the location for the end of the tone from the equation E=(S1+S2)/2.

While the above discussed aspects, arrangements, and embodiments are discussed with specific details and particularity, one or more of the components, steps, features and/or functions illustrated in FIGS. 1, 2, 3, 4, 5, and/or 6 may be rearranged and/or combined into a single component, step, feature or function or embodied in several components, steps, or functions. Additional elements, components, steps, and/or functions may also be added or not utilized without departing from the present disclosure. The apparatus, devices and/or components illustrated in FIGS. 1, 2, and/or 4 may be configured to perform or employ one or more of the methods, features, parameters, and/or steps described in FIGS. 3, 5 and/or 6. The novel algorithms described herein may also be efficiently implemented in software and/or embedded in hardware.

While features of the present disclosure may have been discussed relative to certain embodiments and figures, all embodiments of the present disclosure can include one or more of the advantageous features discussed herein. In other words, while one or more embodiments may have been discussed as having certain advantageous features, one or more of such features may also be used in accordance with any of the various embodiments discussed herein. In similar fashion, while exemplary embodiments may have been discussed herein as device, system, or method embodiments, it should be understood that such exemplary embodiments can be implemented in various devices, systems, and methods.

Also, it is noted that at least some implementations have been described as a process that is depicted as a flowchart, a flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed. A process may correspond to a method, a function, a procedure, a subroutine, a subprogram, etc. When a process corresponds to a function, its termination corresponds to a return of the function to the calling function or the main function. The various methods described herein may be partially or fully implemented by programming (e.g., instructions and/or data) that may be stored in a processor-readable storage medium, and executed by one or more processors, machines and/or devices.

Those of skill in the art would further appreciate that the various illustrative logical blocks, modules, circuits, and algorithm steps described in connection with the embodiments disclosed herein may be implemented as hardware, software, firmware, middleware, microcode, or any combination thereof. To clearly illustrate this interchangeability, various illustrative components, blocks, modules, circuits, and steps have been described above generally in terms of their functionality. Whether such functionality is implemented as hardware or software depends upon the particular application and design constraints imposed on the overall system.

The various features associate with the examples described herein and shown in the accompanying drawings can be implemented in different examples and implementations without departing from the scope of the present disclosure. Therefore, although certain specific constructions and arrangements have been described and shown in the accompanying drawings, such embodiments are merely illustrative and not restrictive of the scope of the disclosure, since various other additions and modifications to, and deletions from, the described embodiments will be apparent to one of ordinary skill in the art. Thus, the scope of the disclosure is only determined by the literal language, and legal equivalents, of the claims which follow.

What is claimed is:

1. An access terminal, comprising:
a communications interface; and
a processing circuit coupled to the communications interface, the processing circuit adapted to:
receive a transmitted tone via the communications interface;
obtain a plurality of samples for the received tone; and
determine a location of the received tone based on a sample exhibiting a maximum correlation value.

2. The access terminal of claim 1, wherein the processing circuit adapted to determine the location of the received tone based on the sample exhibiting the maximum correlation value comprises the processing circuit adapted to:
detect which sample of the plurality of samples exhibits the maximum correlation value.

3. The access terminal of claim 1, wherein the processing circuit adapted to determine the location of the received tone based on the sample exhibiting the maximum correlation value comprises the processing circuit adapted to:
determine that an end of the received tone is located in time at least substantially at the same location as the sample exhibiting the maximum correlation value.

4. The access terminal of claim 1, wherein the processing circuit is further adapted to:
predict a signal-to-noise ratio for the received tone;
determine the location of the received tone based on the sample exhibiting the maximum correlation value when the predicted signal-to-noise ratio (SNR) is equal to or above a predetermined SNR threshold; and
determine the location of the received tone based on a location halfway between a first sample with a correlation value above a predefined correlation threshold and a first subsequent sample with a correlation value below the predefined correlation threshold when the predicted SNR is below the predetermined SNR threshold.

5. The access terminal of claim 4, wherein the processing circuit adapted to predict the signal-to-noise ratio for the received tone comprises the processing circuit adapted to:
obtain a plurality of samples for the transmitted tone;
detect the peak sample that exhibits a maximum correlation value among the plurality of samples; and
calculate the signal-to-noise ratio associated with the peak sample.

6. The access terminal of claim 4, wherein the processing circuit adapted to determine the location of the received tone based on a location halfway between a first sample with a correlation value above a predefined correlation threshold and a first subsequent sample with a correlation value below the predefined correlation threshold comprises the processing circuit adapted to:
identify a location of the first sample (S1) with a correlation value above the predefined correlation threshold;
identify a location of the first subsequent sample (S2) that is first to exhibit a correlation value below the predefined correlation threshold after the sample S1; and calculate a location for an end of the transmitted tone from the sum of the first sample (S1) and the first subsequent sample (S2) divided by 2 ((S1+S2)/2).

7. A method operational on an access terminal, comprising:
obtaining a plurality of samples for a received tone;
detecting which sample of the plurality of samples exhibits a maximum correlation value; and
determining a location of the received tone based on the sample exhibiting the maximum correlation value.

8. The method of claim 7, wherein detecting which sample of the plurality of samples exhibits a maximum correlation value comprises:
monitoring a correlation value associated with each sample during a receive window.

9. The method of claim 8, wherein detecting which sample of the plurality of samples exhibits a maximum correlation value further comprises:
maintaining a running indication of which sample exhibits the maximum correlation value during the receive window.

10. The method of claim 7, wherein determining the location of the received tone based on the sample exhibiting the maximum correlation value comprises:
determining that an end of the received tone is located in time at least substantially at the same location as the sample exhibiting the maximum correlation value.

11. The method of claim 7, further comprising:
predicting a signal-to-noise ratio for the received tone;
determining the location of the received tone based on the sample exhibiting the maximum correlation value when the predicted signal-to-noise ratio (SNR) is above a predetermined SNR threshold; and
determining a location of the received tone based on a central location between a first sample with a correlation value above a predefined correlation threshold and a first subsequent sample with a correlation value below the predefined correlation threshold when the predicted signal-to-noise ratio for the received tone is below the predetermined SNR threshold.

12. The method of claim 11, wherein predicting the signal-to-noise ratio for the received tone comprises:
obtaining a plurality of samples for the received tone;
detecting the peak sample that exhibits a maximum correlation value among the plurality of samples; and
calculating the signal-to-noise ratio for the peak sample.

13. The method of claim 11, wherein determining the location of the received tone based on a central location between the first sample with a correlation value above the predefined correlation threshold and the first subsequent sample with a correlation value below the predefined correlation threshold comprises:
identifying a location of the first sample (S1) with a correlation value above the predefined correlation threshold;
identifying a location of the first subsequent sample (S2) that is first to exhibit a correlation value below the predefined correlation threshold after the sample S1; and
calculating a location for an end of the transmitted tone from the sum of the first sample (S1) and the first subsequent sample (S2) divided by 2 ((S1+S2)/2).

14. An access terminal, comprising:
means for obtaining a plurality of samples for a received tone;
means for detecting which sample of the plurality of samples exhibits a maximum correlation value; and
means for determining a location of the received tone based on the sample exhibiting the maximum correlation value.

15. The access terminal of claim 14, wherein the means for determining the location of the received tone based on the sample exhibiting the maximum correlation value comprises:
means for determining that an end of the received tone is located in time at least substantially at the same location as the sample exhibiting the maximum correlation value.

16. The access terminal of claim 14, further comprising:
means for predicting a signal-to-noise ratio for the received tone;
means for determining the location of the received tone based on the sample exhibiting the maximum correlation value when the predicted signal-to-noise ratio (SNR) is above a predetermined SNR threshold; and
means for determining a location of the received tone based on a central location between a first sample with a correlation value above a predefined correlation threshold and a first subsequent sample with a correlation value below the predefined correlation threshold when the predicted signal-to-noise ratio for the received tone is below the predetermined SNR threshold.

17. The access terminal of claim 16, wherein the means for predicting the signal-to-noise ratio for the received tone comprises:
means for obtaining a plurality of samples for the received tone;
means for detecting the peak sample that exhibits a maximum correlation value among the plurality of samples; and
means for calculating the signal-to-noise ratio for the peak sample.

18. The access terminal of claim 16, wherein the means for determining the location of the received tone based on a central location between the first sample with a correlation value above the predefined correlation threshold and the first subsequent sample with a correlation value below the predefined correlation threshold comprises:
means for identifying a location of the first sample (S1) with a correlation value above the predefined correlation threshold;
means for identifying a location of the first subsequent sample (S2) that is first to exhibit a correlation value below the predefined correlation threshold after the sample S1; and
means for calculating a location for an end of the transmitted tone from the sum of the first sample (S1) and the first subsequent sample (S2) divided by 2 ((S1+S2)/2).

19. A processor-readable storage medium, comprising programming for causing a processing circuit to:
obtain a plurality of samples for a received tone;
detect which sample of the plurality of samples exhibits a maximum correlation value; and
determine a location of the received tone based on the sample exhibiting the maximum correlation value.

20. The processor-readable storage medium of claim 19, wherein the programming for causing a processing circuit to determine the location of the received tone based on the sample exhibiting the maximum correlation value comprises programming for causing a processing circuit to:
determine that an end of the received tone is located in time at least substantially at the same location as the sample exhibiting the maximum correlation value.

21. The processor-readable storage medium of claim 19, further comprising programming for causing a processing circuit to:
predict a signal-to-noise ratio for the received tone;
determine the location of the received tone based on the sample exhibiting the maximum correlation value when the predicted signal-to-noise ratio (SNR) is above a predetermined SNR threshold; and
determine a location of the received tone based on a central location between a first sample with a correlation value above a predefined correlation threshold and a first subsequent sample with a correlation value below the predefined correlation threshold when the predicted signal-to-noise ratio for the received tone is below the predetermined SNR threshold.

22. The method of claim 21, wherein the programming for causing a processing circuit to predict the signal-to-noise ratio for the received tone comprises programming for causing a processing circuit to:
obtain a plurality of samples for the received tone;
detect the peak sample that exhibits a maximum correlation value among the plurality of samples; and
calculate the signal-to-noise ratio for the peak sample.

23. The method of claim 21, wherein the programming for causing a processing circuit to determine the location of the received tone based on a central location between the first sample with a correlation value above the predefined correlation threshold and the first subsequent sample with a correlation value below the predefined correlation threshold comprises programming for causing a processing circuit to:
identify a location of the first sample (S1) with a correlation value above the predefined correlation threshold;
identify a location of the first subsequent sample (S2) that is first to exhibit a correlation value below the predefined correlation threshold after the sample S1; and
calculate a location for an end of the transmitted tone from the sum of the first sample (S1) and the first subsequent sample (S2) divided by 2 ((S1+S2)/2).
